(19) United States
(12) Patent Application Publication
(10) Pub. No.: US 2020/0320637 A1
(43) Pub. Date: Oct. 8, 2020

(54) AUTOMATED POTENTIAL RISK RELATIONSHIP INITIAL REVIEW AND FINALIZATION VIA PARTNER PLATFORM

(71) Applicants: Dharmesh R. Pandya, West Hartford, CT (US); Arif H Khan, West Hartford, CT (US); Aleeza E. Liu, Charlotte, NC (US); Lauren E. Lett, Simsbury, CT (US); Vannak Sin, Avon, CT (US); Mairead L. Riley, Concord, NC (US); Peter M. Hill, Bloomfield, CT (US)

(72) Inventors: Dharmesh R. Pandya, West Hartford, CT (US); Arif H Khan, West Hartford, CT (US); Aleeza E. Liu, Charlotte, NC (US); Lauren E. Lett, Simsbury, CT (US); Vannak Sin, Avon, CT (US); Mairead L. Riley, Concord, NC (US); Peter M. Hill, Bloomfield, CT (US)

(21) Appl. No.: 16/826,961

(22) Filed: Mar. 23, 2020

Related U.S. Application Data
(60) Provisional application No. 62/829,915, filed on Apr. 5, 2019.

(51) Int. Cl. G06Q 40/08

(52) U.S. Cl. CPC G06Q 40/08

(57) ABSTRACT

An automated potential risk relationship platform may ingest potential risk relationship data, from a remote partner platform, associated with an entity and including an entity identifier. The system may supplement the potential risk relationship data with third-party data received from a remote third-party platform and determine that the supplemented potential risk relationship data qualifies for a resource calculation process. If the supplemented potential risk relationship data qualifies for the resource calculation process, the system may then automatically calculate a resource value for the entity based on the supplemented potential risk relationship data and transmit an indication of the calculated resource value to the partner platform. An automated risk relationship finalization computer server may receive an indication that the entity requested that a finalization process be executed and, responsive to the received indication, execute the finalization process in accordance with the supplemented potential risk relationship data and the calculated resource value.

### CROSS-REFERENCE TO RELATED APPLICATIONS

The present application claims the benefit of U.S. Provisional Patent Application No. 62/829,915 entitled “AUTOMATED POTENTIAL RISK RELATIONSHIP INITIAL REVIEW AND FINALIZATION VIA PARTNER PLATFORM” and filed Apr. 5, 2019.

### BACKGROUND

An entity might enter into a risk relationship with an enterprise (e.g., as a form of risk management). For example, a small business owner might purchase an insurance policy from an insurer (e.g., workers' compensation, automobile liability, automobile property damage, general liability insurance, etc.) in connection with one or more employees, buildings, etc. Note that a risk relationship may be associated with attribute values (e.g., payroll amounts, employee job classifications, etc.) that an enterprise will evaluate to determine a resource value, such as an insurance premium. Entering this type of information, however, can be a time consuming, difficult, and error prone task for a small business owner. Further note that a small business owner might have already provided some or all of these attributes via one or more business applications (e.g., an accounting application, a payroll application, and/or a human resource application).

It would be desirable to provide systems and methods to facilitate performance of a resource value calculation and finalization process for a potential risk relationship an efficient and accurate fashion.

### SUMMARY OF THE INVENTION

According to some embodiments, systems, methods, apparatus, computer program code and means are provided with an automated risk relationship finalization computer server associated with an enterprise. An automated potential risk relationship platform may ingest potential risk relationship data, from a remote partner platform, associated with an entity and including an entity identifier. The system may supplement the potential risk relationship data with third-party data received from a remote third-party platform and determine that the supplemented potential risk relationship data qualifies for a resource calculation process. If the supplemented potential risk relationship data qualifies for the resource calculation process, the system may then automatically calculate a resource value for the entity based on the supplemented potential risk relationship data and transmit an indication of the calculated resource value to the partner platform. The automated risk relationship finalization computer server may receive an indication that the entity requested that a finalization process be executed and, responsive to the received indication, execute the finalization process in accordance with the supplemented potential risk relationship data and the calculated resource value.

Some embodiments comprise: means for ingesting, at an automated potential risk relationship platform from a remote partner platform, potential risk relationship data associated with an entity including an entity identifier; means for supplementing the potential risk relationship data with third-party data received from a remote third-party platform; means for determining that the supplemented potential risk relationship data qualifies for a resource calculation process; if the supplemented potential risk relationship data qualifies for the resource calculation process, means for automatically calculating a resource value for the entity based on the supplemented potential risk relationship data; means for transmitting an indication of the calculated resource value to the partner platform; means for receiving, at the automated risk relationship finalization computer server, an indication that the entity requested that a finalization process be executed; and, responsive to the received indication, means for executing the finalization process in accordance with the supplemented potential risk relationship data and the calculated resource value.

In some embodiments, a communication device associated with an automated risk relationship finalization computer server exchanges information with remote devices in connection with an interactive graphical user interface. The information may be exchanged, for example, via public and/or proprietary communication networks.

A technical effect of some embodiments of the invention is an improved and computerized way to facilitate performance of a resource value calculation and finalization process for a potential risk relationship an efficient and accurate fashion. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system in accordance with some embodiments.

FIG. 2 illustrates a method according to some embodiments of the present invention.

FIG. 3 is a more detailed block diagram of an insurance system in accordance with some embodiments.

FIG. 4 illustrates an overall architecture according to some embodiments.

FIG. 5 is a process flow in accordance with some embodiments.

FIG. 6 is a process flow in accordance with another embodiment.

FIG. 7 is an experience flow in accordance with some embodiments.

FIG. 8 illustrates a user experience according to some embodiments.

FIG. 9 is a partner display in accordance with some embodiments.

FIG. 10 is an example of a business insurance proposal display according to some embodiments.

FIG. 11 is a small business insurance quote display in accordance with some embodiments.

FIG. 12 illustrates a display to gather LLC information according to some embodiments.

FIG. 13 is a payment plan selection display in accordance with some embodiments.

FIG. 14 is a payment type selection display according to some embodiments.

FIG. 15 is a finalization display in accordance with some embodiments.

FIG. 16 is a block diagram of an apparatus in accordance with some embodiments of the present invention.

FIG. 17 is a portion of a tabular insurance database according to some embodiments.

FIG. 18 illustrates a tablet computer displaying a business application interface according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record attribute update, utilization, and/or analysis by providing benefits in data accuracy, data availability, data comprehension, data analysis, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via an automated potential risk relationship platform and/or an automated risk relationship finalization computer server to accurately improve the exchange of information, thus improving the overall efficiency of the system associated with message storage requirements and/or bandwidth considerations (e.g., by reducing the number of messages that need to be transmitted via a network, by improving response times, by automatically ingesting and combining information, and/or by creating more complete and/or accurate relationship decisions). Moreover, embodiments associated with collecting accurate information might further improve risk values, resource values, allocations of resources, electronic record processing decisions, etc.

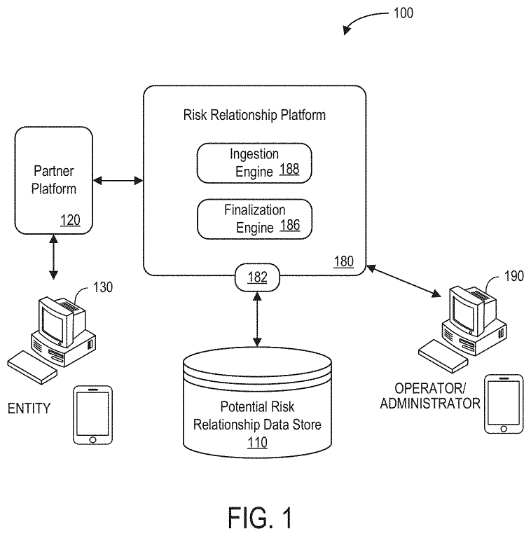

Note that a risk relationship may be associated with attribute values (e.g., payroll amounts, employee job classifications, etc.) that an enterprise will evaluate to determine a resource value, such as an insurance premium. Entering this type of information, however, can be a time consuming, difficult, and error prone task for a small business owner. To address this issue, FIG. 1 is a high-level block diagram of a system 100 according to some embodiments of the present invention. In particular, the system 100 includes a potential risk relationship platform 180 that may access information in a potential risk relationship data store 110 (e.g., storing a set of electronic records representing risk relationships, each record including, for example, one or more potential risk relationship identifiers, payroll data, job classification, attribute variables, resource values, etc.). The potential risk relationship platform 180 may also exchange information with a “partner” platform 120 to verify, update, and/or utilize electronic records. As used herein the term “partner” may be associated with a business application (e.g., tax preparation software) who has partnered with an enterprise (e.g., an insurance company). Information provided by small business owner can then, for example, be used by the enterprise to make potential risk relationship offers or decisions.

The potential risk relationship platform 180 may also exchange information with a remote operator or administrator device 190 (e.g., via a firewall). According to some embodiments, an interactive graphical user interface engine of the potential risk relationship platform 180 (and, in some cases, third-party data) may facilitate document creation, decisions, predictions, and/or the display of summary results via one or more remote administrator displays or portals (e.g., to gather additional information about potential customer). An ingestion engine 188 may process information about an entity 130 received via the partner platform 120 (e.g., a cloud-based accounting program). A finalization engine 186 may establish an actual risk relationship for the entity. After a review of the appropriate information, the potential risk relationship platform 180 may adjust data in the potential risk relationship data store 110, automatically create a new potential risk relationship offer or agreement, generate electronic messages or calendar events, etc. Note that the potential risk relationship platform 180 and/or any of the other devices and methods described herein might be associated with a third party, such as company that performs a service for an enterprise.

The potential risk relationship platform 180 and/or the other elements of the system 100 might be, for example, associated with a Personal Computer (“PC”), laptop computer, smartphone, an enterprise server, a server farm, and/or a database or similar storage devices. According to some embodiments, an “automated” potential risk relationship platform 180 (and/or other elements of the system 100) may facilitate ingesting and finalizing electronic records in the potential risk relationship data store 110. As used herein, the term “automated” may refer to, for example, actions that can be performed with little (or no) intervention by a human.

As used herein, devices, including those associated with the potential risk relationship platform 180 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a BLUETOOTH™ network, a wireless LAN network, and/or an Internet Protocol (“IP”) network such as the Internet, an intranet, or an extranet. Note that any devices described herein may communicate via one or more such communication networks.

The potential risk relationship platform 180 may store information into and/or retrieve information from the potential risk relationship data store 110. The potential risk relationship data store 110 might, for example, store electronic records representing a plurality of risk relationships, each electronic record having a set of attribute values. The potential risk relationship data store 110 may also contain information about prior and current interactions with parties, including those associated with various partner platforms 120 and remote devices 180. The potential risk relationship data store 110 may be locally stored or reside remote from the potential risk relationship platform 180. As will be described further below, the potential risk relationship data store 110 may be used by the potential risk relationship platform 180 in connection with an interactive user interface to update electronic records. Although a single potential risk relationship platform 180 is shown in FIG. 1, any number of such devices may be included. Moreover, various devices described herein might be combined according to embodiments of the present invention. For example, in some embodiments, the potential risk relationship platform 180 and operator or administrator device 190 might be co-located and/or may comprise a single apparatus.

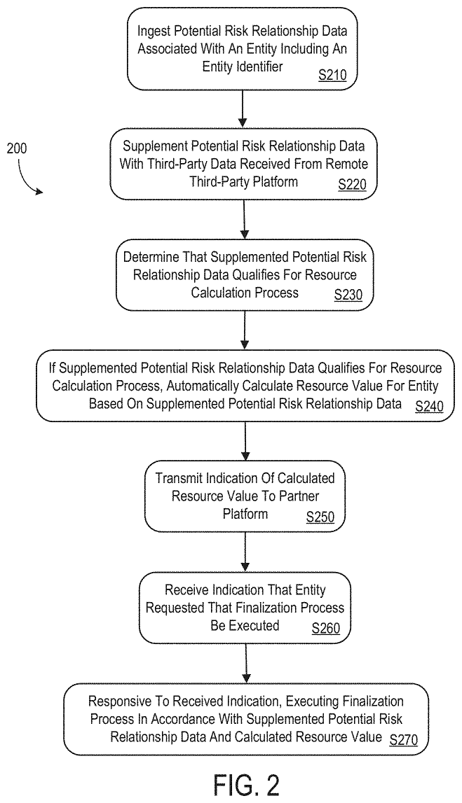

Note that the system 100 of FIG. 1 is provided only as an example, and embodiments may be associated with additional elements or components. According to some embodiments, the elements of the system 100 automatically exchange information associated with a partner's interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The method 200 may, in some embodiments, utilize an automated risk relationship finalization computer server associated with an enterprise (e.g., an insurance company). In particular, at S210 an automated potential risk relationship platform may ingest, from a remote partner platform, potential risk relationship data associated with an entity including an entity identifier. According to some embodiments, the potential risk relationship is associated with an insurance policy and the resource value is associated with an insurance premium amount. Moreover, the entity may comprise a small business owner and the insurance policy might be associated workers' compensation insurance, a business owner's insurance policy, general liability insurance, automotive insurance, etc. The partner platform might be associated with, for example, a payroll application, an accounting application, a human resource application, a tax preparation application, an Enterprise Resource Management System (“ERMS”) application, etc.

At S220, the system may supplement the potential risk relationship data with third-party data received from a remote third-party platform. The third-party data might be associated with, for example, governmental data (e.g., a department of motor vehicles), credit score company data, map-based geographic data, internal data associated with the enterprise, etc. The supplemented potential risk relationship data might include, for example, a business name, a business address, an industry code, a business age, a number of employees, an amount of sales, a payroll value, a number of square feet associated with business building, a building type, a business communication address (e.g., email address, telephone number, or postal address), etc. Note that the ingested potential risk relationship data and/or supplemented potential risk relationship data might be dynamically adjusted to take into account the types of data (and/or the quality of data) available from various sources (e.g., from remote partner platforms and/or third-party platforms).

At S230, the system may determine that the supplemented potential risk relationship data qualifies for a resource calculation process. According to some embodiments, the resource calculation process is further based on a risk attribute filter associated with the entity (e.g., a set of small business “risk attributes” generated by an insurance company). Note that qualification for the resource calculation process might include, for example: determining if the entity is a current customer of the enterprise; determining if the enterprise is interested in the potential risk relationship; a type of insurance; a business classification algorithm, etc.

If the supplemented potential risk relationship data qualifies for the resource calculation process, the system may automatically calculate a resource value for the entity based on the supplemented potential risk relationship data at S240. The system may then transmit an indication of the calculated resource value to the partner platform at S250. According to some embodiments, an automated potential risk relationship platform may be configured to perform steps S210 through S250 in a relatively short period of time (e.g., within ten seconds). At S260, the automated risk relationship finalization computer server may receive an indication that the entity requested that a finalization process be executed. The indication might be received by the automated risk associated finalization computer server via the partner platform, a remote device associated with the entity, an agency platform, a web page, a telephone call, etc.

Responsive to the received indication, at S270 the system may execute the finalization process in accordance with the supplemented potential risk relationship data and the calculated resource value. The finalization process might include, for example: receiving from the entity adjustments to the supplemented potential risk relationship data; re-calculating the insurance premium amount based on the adjustment; issuing an insurance policy in accordance with the re-calculated insurance premium amount, etc.

In some embodiments, a communication port coupled to the automated risk relationship finalization computer server may facilitate an exchange of data with a remote administrator platform to support a potential risk relationship interface display via a distributed communication network. Moreover, a potential risk relationship data store, coupled to the automated risk relationship finalization computer server, may contain electronic records associated with the entity, each electronic record including an electronic record identifier and a set of attribute values including the calculated resource value.

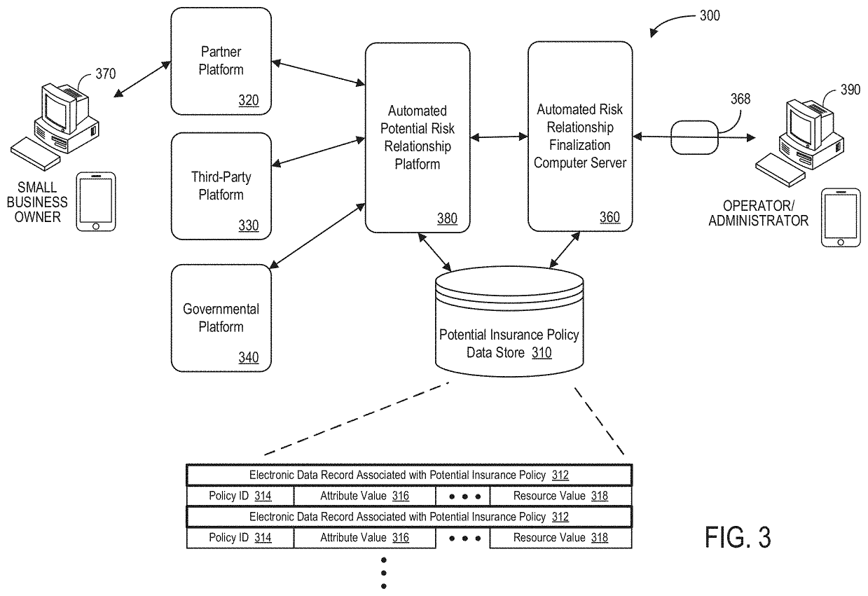

According to some embodiments, the “potential risk relationships” are associated with potential insurance policies and/or insurance premium quotes (e.g., bindable, non-bindable, estimated, etc.) and at least some attribute and resource values are associated with insurance premiums. For example, FIG. 3 is a more detailed block diagram of a system 300 according to some embodiments. As before, the system 300 includes an automated potential risk relationship platform 380 that may access information in a potential insurance policy data store 310 (e.g., storing a set of electronic data records 312 representing insurance policies, each data record including, for example, one or more insurance policy identifiers 314, attribute variables 316, resource values 318 such as insurance premiums, etc.). The automated potential risk relationship platform 380 may also retrieve information from an partner platform 320 (e.g., with updated payroll data or newly added human resource data), a third-party platform 330 (e.g., to pre-populate underwriting and quote generation information), and/or a governmental platform 340 (e.g., a number of automobiles registered to a business based on a state's department of motor vehicle record information) to update or utilize the electronic data records. The automated potential risk relationship platform 380 may access information about a small business owner from the partner platform 320 (e.g., payroll information provided by the owner via an owner device 370), automatically generate an insurance quote based on that information, and present an insurance offer (including a premium value) to the small business owner via the partner platform 310. The automated potential risk relationship platform 380 may also exchange information with an automated risk relationship finalization computer server 360. The automated risk relationship finalization computer server 360 may, for example, execute functions connected with issuing an actual insurance policy for the small business owner. According to some embodiments, the automated risk relationship finalization computer server 360 exchanges information with a remote operator or administrator terminals 390 (e.g., via a firewall 368) to receive information about qualification algorithms, provide summary information, etc. According to some embodiments, an interactive graphical user interface and/or algorithm of the system 300 may facilitate document creation, decisions, predictions, and/or the display of results via one or more remote administrator computers 390. According to some embodiments, the automated potential risk relationship platform 380 and/or automated risk relationship finalization computer server 360 may transmit information to an email server, workflow application, or calendar function (e.g., to generate reminders when an account needs to perform a certain action).

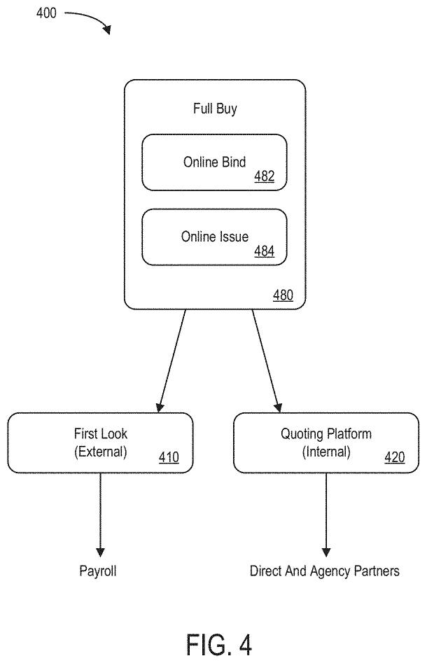

FIG. 4 illustrates an overall architecture 400 according to some embodiments. A full buy process 480 may be associated with an online bind 482 (e.g., providing a bindable quote—including an insurance premium—to a potential customer via a partner web site, application, or any other means) and an online issue (e.g., issuing an insurance policy to the customer). The full buy process 480 might interact via an external first look platform 410 (e.g., via a payroll or other business application associated with a partner platform) and/or an internal quoting platform 420 (e.g., directly or via an insurance agency partner).

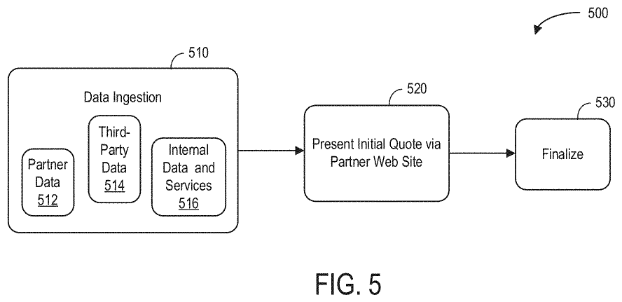

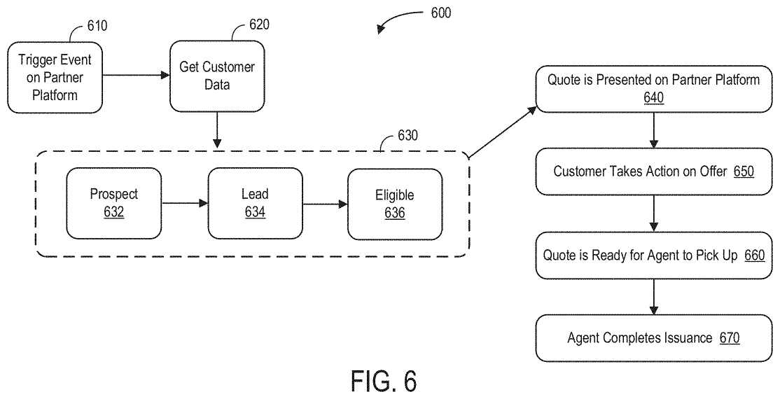

In this way, the full buy process 480 may provide a small commercial insurance provider's ability to issue a bindable quote directly with a small business owner. The first look platform 410 may be provide an ability to externalize the full buy process 480 capabilities via a partner's site to produce a bindable quote and issue an insurance policy. The bindable quote may be produced, according to some embodiments, using data supplied by a partner, third party data, and/or internal data and services. According to some embodiments, product offerings, limits, and underwriting questions may be defaulted so that a small business owner does not need to input data to produce a bindable quote. The underlining services from the full buy process 480 may be enablers, according to some embodiment, to a payroll channel via the first look platform 410 (e.g., as described with respect to FIG. 5) and/or the direct or insurance agency partners quoting platform 420 (e.g., as described with respect to FIG. 6).

FIG. 5 is a process flow 500 in accordance with some embodiments. At 510, data may be ingested from a partner platform, and a quote may be produced using an enterprise system. The ingestion of data might include partner data 512, third-party data 514, and/or internal data and services 516. If the small business owner is first look eligible, then an initial quote offer may be shown to the small business owner via a partner's website (include a quoted price) at 520. At 530, after the small business owner views quote details and completes the purchase process quote platform, the system may use existing processes and full buy capabilities to issue the insurance policy to the small business owner.

Consider a business owner who might be interested in purchasing workers' compensation insurance (and who provides payroll data to a partner platform). In this case, the process flow 500 may enable first look abilities and take advantage of a mature payroll distribution channel with potential partners (e.g., payroll software bureaus) and increase access to workers' compensation premiums in a payroll channel. Moreover, embodiments may improve the availability of credible data (e.g., wages, Full-Time Equivalent (“FTE”) information, etc.) for product and/or coverage definition, rating, pricing, etc.

The process flow 500 may implement shared capabilities such that aspects of a full buy process may be leveraged by a first look process. The capabilities may include, for example, underwriting questions, a workers' compensation bindable quote, a business owners policy bindable quote, workers' compensation issuance, business owner's insurance policy issuance, etc. In addition, service integrations might utilize small business owner scores, existing customer clearance data, catastrophe and terrorism holds, etc.

FIG. 6 is a process flow 600 in accordance with another embodiment. At 610, a trigger event occurs at a partner platform in connection with a potential customer's use of a business application. For example, the potential customer might be a small business owner who adds an employee to a payroll application, uploads new sales figures, etc. At 620, an enterprise (e.g., an insurance company) receives information about the trigger event from the partner platform (e.g., a business name, contact information, an address, a number of employees, payroll information, etc.). At 630, the enterprise determines the potential customer's eligibility to receive an insurance quote. In particular, a prospect process 632 might determine if the party is already a customer and/or perform an automatic classification of the customer's business. A lead process 634 might determine if the enterprise has an appetite for that type of business. An eligibility process 636 might utilze third-party data to pre-fill a portion of a quote database, use one or more risk attribute filters to determine a small business owner's suitability to receive a quote, predict what type of insurance product the potential customer might be interested in, etc.

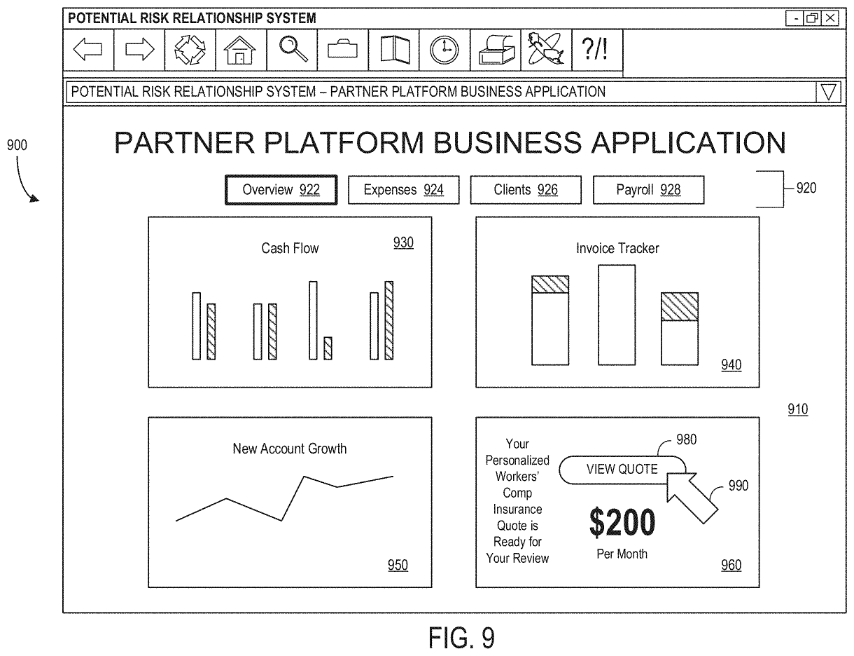

At 640, the enterprise presents the quote to the potential customer via the partner platform (e.g., as described in connection with FIG. 9). At 650, the small business owner takes an action in response to the offer (e.g., by clicking on an icon, placing a telephone call, etc.). At 660, the enterprise uploads information about the quote into a platform available to insurance agents. At 670, the insurance agent accesses the uploaded information and completes the process such that a final insurance policy is issued.

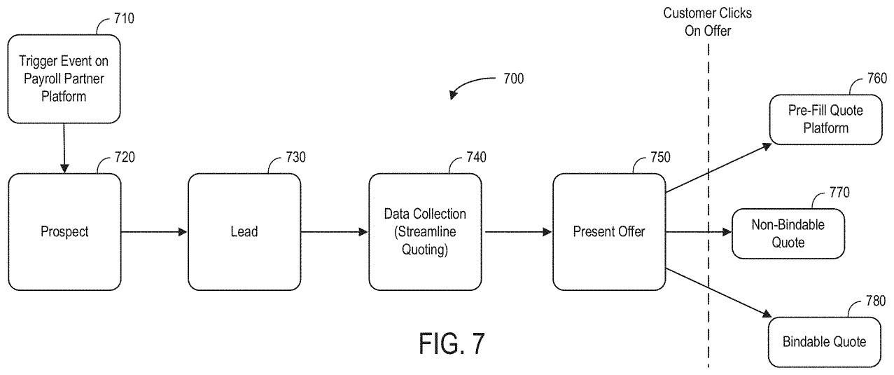

FIG. 7 is an experience flow 700 in accordance with some embodiments. At 710, a trigger event is detected on a partner's platform. A prospect process 720 may then determine if an entity associated with the trigger is already a current customer and/or a type of business associated with the entity. A lead process 730 may determine if the insurance company is interested (e.g., has an “appetite for”) that potential customer. A data collection process 740 may use third-party data to pre-fill information for a quote engine, utilize a small business owner risk attribute filter, and/or predict a type of insurance that might be of interest to the business owner.

An offer presentation process 750 may then present one of several different types of offers to the business owner.

For example, if there is not enough data for an accurate quote (but the enterprise does have an appetite for that type of business) an estimated quote may be provided. If there is enough data to generate an accurate quote but information does not qualify for a bindable quote (e.g., due to poor risk filter attributes), a predicted premium might be displayed along with an indication that further questions need to be answered. If there is enough data to generate a quote and the information qualifies for a bindable quote, a price page may be displayed with the bindable quote. Responsive to the presentation of the offer, the customer may take a specific action (e.g., by clicking on an icon) which may result in pre-filling data on a quote platform 760, pursuit of the non-bindable quote 770, or the display of the price page including the bindable insurance premium value 780.

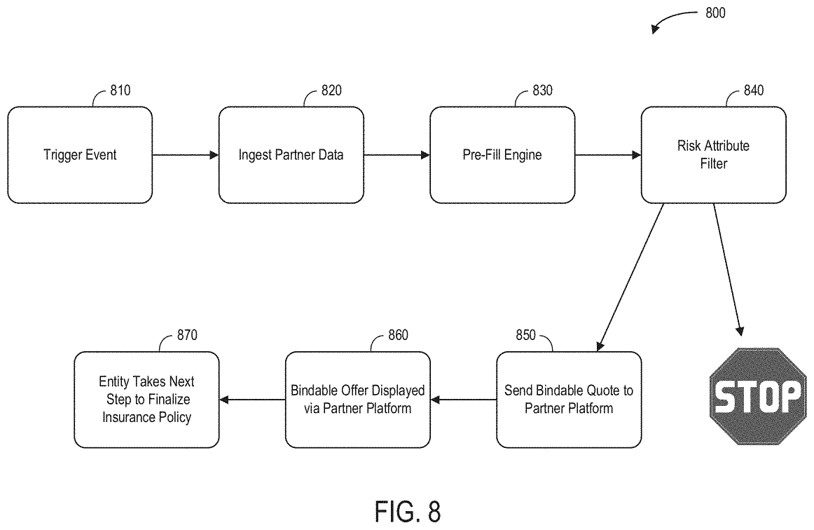

FIG. 8 illustrates a user experience 800 according to some embodiments. At 810, a trigger event may occur on a partner's site. Responsive to the trigger event, at 820 the partner transmits information to the insurance company (e.g., a business name, a business contact name, a location address and ZIP code, a number of employees and total payroll from the last pay cycle, etc.). At 830, insurance company takes the partner data and uses third-party data (and, if applicable) internal data sources to pre-fill data and determine: customer clearance and a reserved agent quote; an industry/class assignment via smart classification; a small business owner risk attribute filter, etc. At 840, if a lead has acceptable small business owner risk filter attributes, they are eligible to proceed through the rest of the first look quote flow. Some third-party services or defaults that might be used to produce a quote include: workers' compensation additional rating factors (e.g. claim frequency and business credit), workers' compensation pricing variables (e.g., experience modifiers, job codes, National Council for Compensation Insurance (“NCCI”) data, etc.), and coverage defaults (e.g., basic form, owner election status, employee liability limits, an effective date, an expiration date, etc.). If a bindable quote cannot be produced at 840, the process stops. If a bindable quote can be produced at 840, the insurance company passes the quote back to the partner's site at 850. At 860, bindable quote offer is displayed on the partner's website for the small business owner. At 870, the small business owner clicks on a “Call to Action” link in the offer, which results in exiting the partner site and visiting a quoting platform.

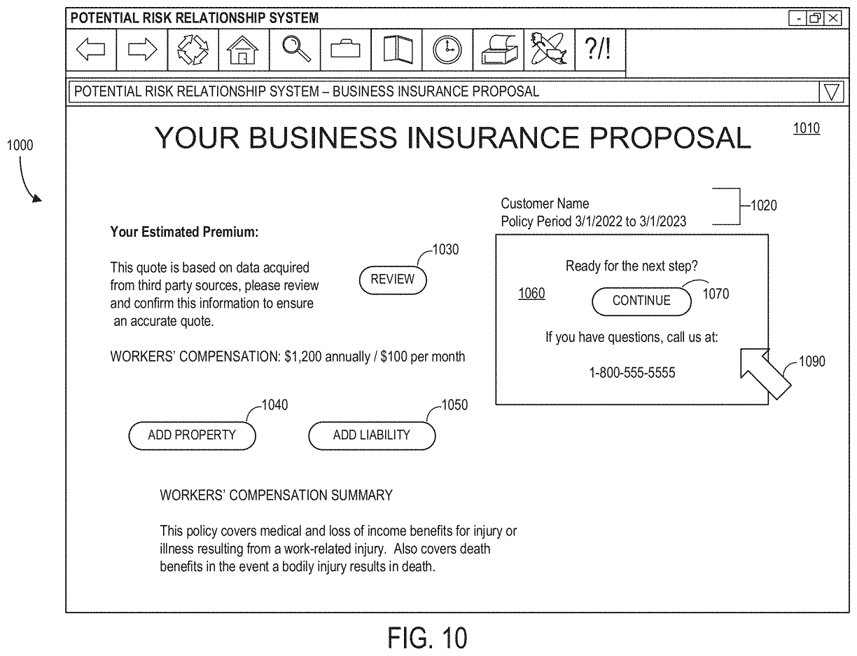

For example, FIG. 9 is a partner display 900 in accordance with some embodiments. The display 900 includes graphical elements 910 associated with a business application. For example, a business owner might use selections 920 to navigate through the application. The application might include graphical display of cash flow data 930, invoice tracking information 940, new account growth 950, etc. According to some embodiments, the display 900 further includes an offer 960 from an insurance company including a bindable (or non-bindable) premium value. Moreover, selection of a “View Quote” icon 980 (e.g., via a touchscreen or computer mouse pointer 990) may result in the owner leaving the business application and visiting the insurance company's web site (or contacting an insurance agent) for further details as illustrated in FIG. 10.

FIG. 10 is an example of a business insurance proposal display 1000 according to some embodiments. The display 900 includes graphical elements 1010 providing details of an insurance quote for a small business owner as identified in area 1020. The owner can select a “Review” icon 1030 to evaluate the information that was used to generate the quote. An “Add Property” icon 1040 and an “Add Liability” icon 1050 may be selected to add additional types of insurance. When the small business owner is ready to purchase the insurance, he or she may select a “Continue” icon 1070 in finalization area 1060 (e.g., via a computer mouse pointer 1090) to complete the process.

Thus, the small business owner may land on the quote page 1000 with the quote generated via a first look process populated in a quoting platform (e.g., which may be co-branded with a partner's logo). The small business owner can edit the quote and an alert message may be shown above the price (e.g., near the “Review” icon 1030). Assumed/defaulted information can be provided in a workers' compensation summary section (not illustrated in FIG. 10) to give information beyond simple liability coverage limits. According to some embodiments, this data can be edited by the owner by clicking on an “Edit” icon in the summary section. If the owner navigates back to a product page or uses one of the “Add” icons 1040, 1050 he or she is able to add another Line Of Business (“LOB”) to the quote. Note that if the owner edits the workers' compensation quote produced via the first look process, attribute values may change resulting in the transaction no longer being qualified for a bindable quote.

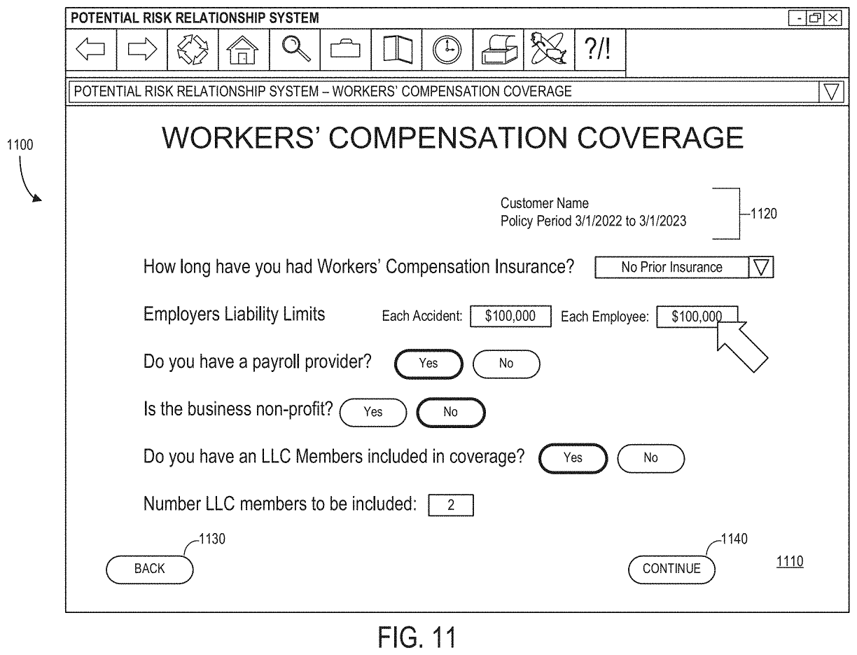

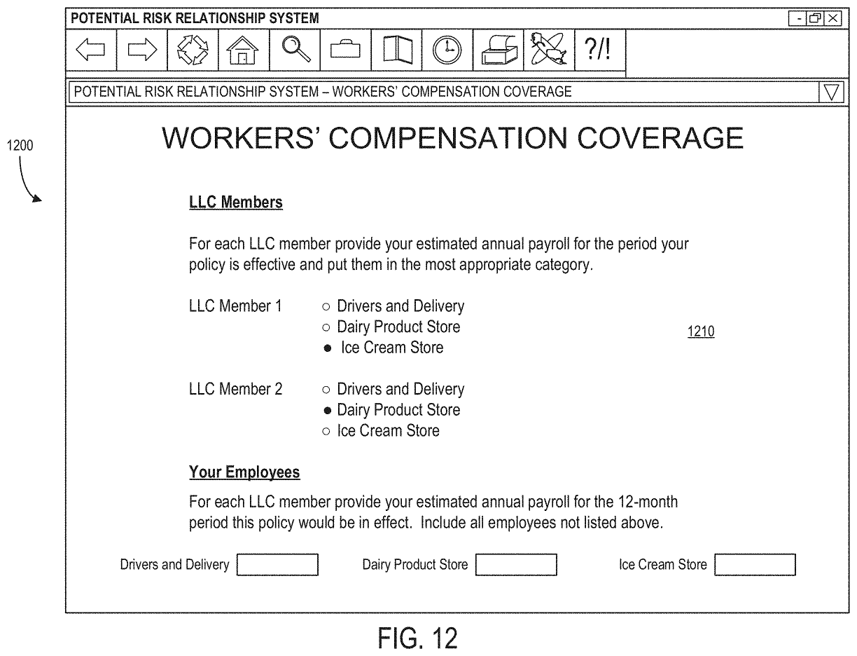

FIG. 11 is a small business insurance quote display 1100 that might be associated with, for example, an enterprise such as an insurer in accordance with some embodiments. The display 1100 includes graphical elements 1110 of a workers' compensation coverage data entry area for a small business owner 1120. The display 1100 may be used by the small business owner to enter information or to modify information that has been pre-populated for the owner (e.g., an enterprise web page partially completed based on data obtained from a partner business application platform, a third-party platform, an internal insurance company database, etc.). The owner can use a “Back” icon 1130 and a “Forward” icon 1140 to navigate through the system to provide additional information. For example, selection of the “Forward” icon 1140 might result in the display 1200 of FIG. 12 to gather Limited Liability Corporation (“LLC”) information according to some embodiments. The display 1200 includes graphical elements 1210 that the small business owner can use to provide member job classification data, employee payroll information, etc.

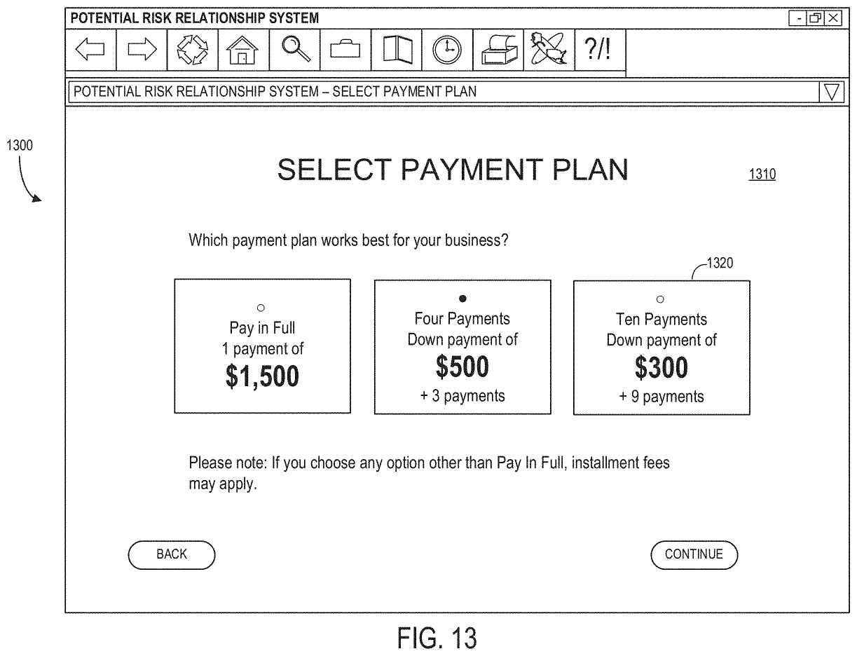

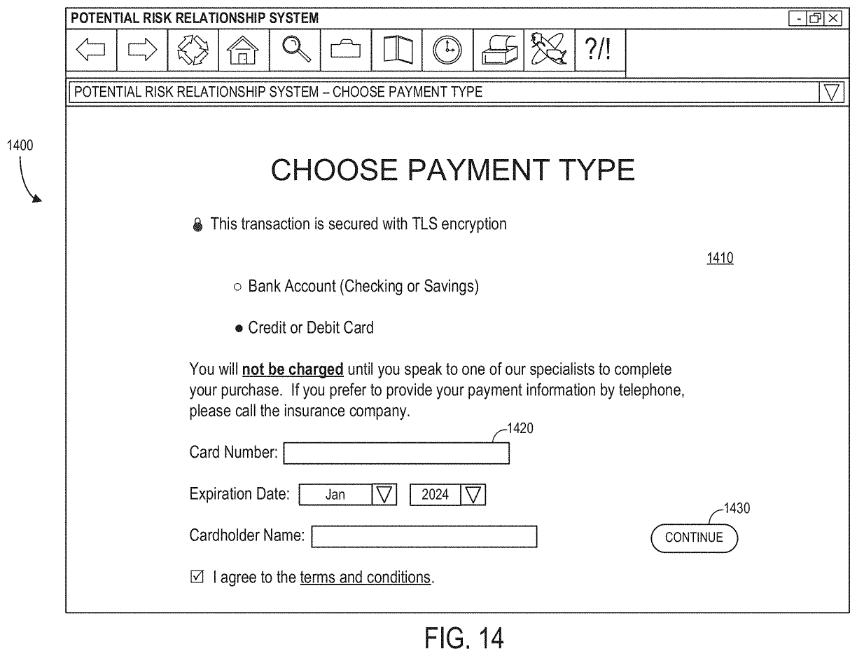

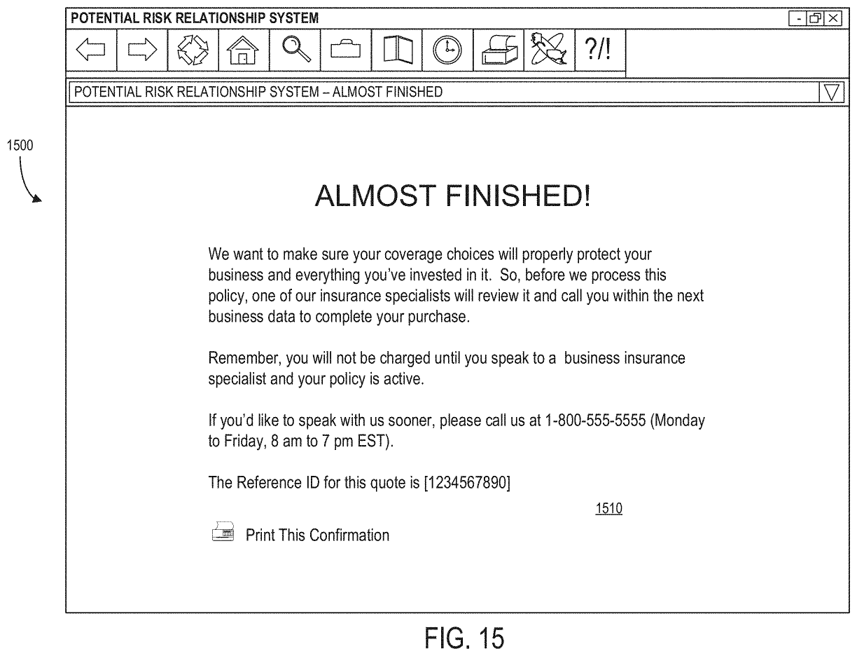

FIG. 13 through 15 are associated with finalization of an insurance offer. In particular, FIG. 13 is a payment plan selection display 1300 in accordance with some embodiments. The display 1300 includes graphical elements 1310 that a small business owner can use to select an appropriate payment plan 1320 for the insurance policy. FIG. 14 is a payment type selection display 1400 according to some embodiments. The display 1400 includes graphical elements 1410 that may be used by the small business owner to select a payment type (e.g., via a bank account, credit card, etc.) and/or payment details 1420. Selection of a “Continue” icon 1430 may result in display of a confirmation page, such as the finalization display 1500 illustrated in FIG. 15 in accordance with some embodiments. The display 1500 includes graphical elements 1510 setting forth expectations on certification of insurance, how to access an online customer account, etc.

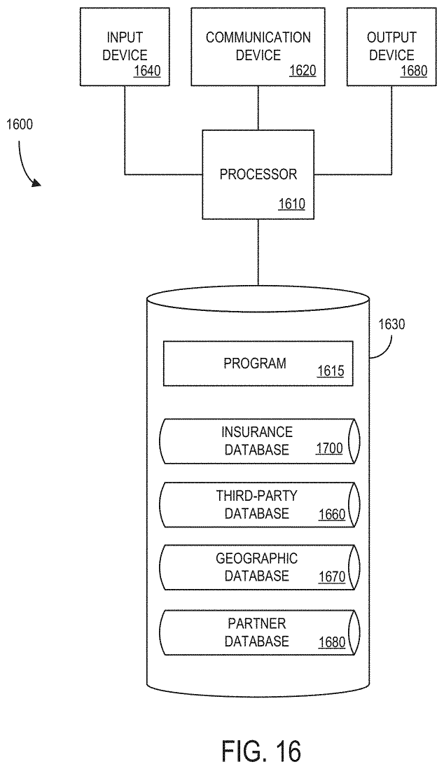

The embodiments described herein may be implemented using any number of different hardware configurations. For example, FIG. 16 illustrates an apparatus 1600 that may be, for example, associated with the systems 100, 300 described with respect to FIGS. 1 and 3, respectively. The apparatus 1600 comprises a processor 1610, such as one or more commercially available Central Processing Units (“CPUs”) in the form of one-chip microprocessors, coupled to a communication device 1620 configured to communicate via a communication network (not shown in FIG. 16). The communication device 1620 may be used to communicate, for example, with one or more remote administrator computers and or communication devices (e.g., PCs and smartphones). Note that communications exchanged via the communication device 1620 may utilize security features, such as those between a public internet user and an internal network of the insurance enterprise. The security features might be associated with, for example, web servers, firewalls, and/or PCI infrastructure. The apparatus 1600 further includes an input device 1640 (e.g., a mouse and/or keyboard to enter information about quote qualification rules or logic) and an output device 1650 (e.g., to output reports regarding account statistics and analytics).

The processor 1610 also communicates with a storage device 1630. The storage device 1630 may comprise any appropriate information storage device, including combinations of magnetic storage devices (e.g., a hard disk drive), optical storage devices, mobile telephones, and/or semiconductor memory devices. The storage device 1630 stores a program 1615 and/or a risk evaluation tool or application for controlling the processor 1610. The processor 1610 performs instructions of the program 1615, and thereby operates in accordance with any of the embodiments described herein. For example, the processor 1610 may ingest potential risk relationship data, from a remote partner platform, associated with an entity and including an entity identifier. The processor 1610 may supplement the potential risk relationship data with third-party data received from a remote third-party platform and determine that the supplemented potential risk relationship data qualifies for a resource calculation process. If the supplemented potential risk relationship data qualifies for the resource calculation process, the processor 1610 may then automatically calculate a resource value for the entity based on the supplemented potential risk relationship data and transmit an indication of the calculated resource value to the partner platform. The processor 1610 may receive an indication that the entity requested that a finalization process be executed and, responsive to the received indication, execute the finalization process in accordance with the supplemented potential risk relationship data and the calculated resource value.

The program 1615 may be stored in a compressed, uncompiled and/or encrypted format. The program 1615 may furthermore include other program elements, such as an operating system, a database management system, and/or device drivers used by the processor 1610 to interface with peripheral devices.

As used herein, information may be “received” by or “transmitted” to, for example: (i) the automated risk relationship finalization computer server 1600 from another device; or (ii) a software application or module within the automated risk relationship finalization computer server 1600 from another software application, module, or any other source.

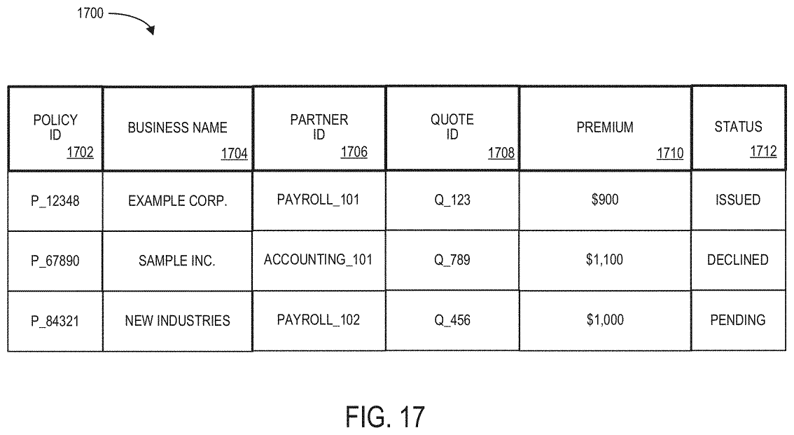

In some embodiments (such as shown in FIG. 16), the storage device 1630 further stores an insurance database 1700, a third-party database 1660 (e.g., storing credit score or governmental information), a geographic database 1670 (e.g., storing ZIP code or street address information), and a partner database 1680 (e.g., storing information about payroll providers, accounting applications, and ERPS platforms). An example of a database that might be used in connection with the apparatus 1600 will now be described in detail with respect to FIG. 17. Note that the database described herein is only an example, and additional and/or different information may be stored therein. Moreover, various databases might be split or combined in accordance with any of the embodiments described herein. For example, the insurance database 1700 and the geographic database 1670 might be combined and/or linked to each other within the program 1615.

Referring to FIG. 17, a table is shown that represents the insurance database 1700 that may be stored at the apparatus 1700 according to some embodiments. The table may include, for example, entries associated with insurance policies that have been (or may potentially will be) issued. The table may also define fields 1702, 1704, 1706, 1708, 1710, 1712 for each of the entries. The fields 1702, 1704, 1706, 1708, 1710, 1712 may, according to some embodiments, specify: a policy identifier 1702, a business name 1704, a partner identifier 1706, a quote identifier 1708, a premium 1710, and a status 1712. The insurance database 1700 may be created and updated, for example, when a trigger event is detected at a partner platform, when an insurance policy is renewed, when new information is received from a small business owner, etc.

The policy identifier 1702 may be, for example, a unique alphanumeric code identifying an insurance policy (e.g., workers' compensation, automobile liability, automobile property damage, general liability insurance, property insurance, casualty insurance, group benefit insurance, etc.) for an entity identified by the business name 1704. The partner identifier 1706 may identify the business application that triggered an insurance offer associated with the quote identifier 1708. The premium 1710 may comprise a dollar amount associated with the quote (and may or may not be bindable). The status 1712 might indicate that the quote was issued by the insurance company, was declined by the small business owner, is still pending (or expired), etc.

Thus, embodiments of the present invention may provide an ability to externalize full buy capabilities via a partner's site to produce a bindable quote and issue an insurance policy. The bindable quote may be produced using data supplied by the partner, third-party data and internal insurance company data/services. Product offerings, limits and underwriting questions may be defaulted so that a small business owner does not need to input any data in order to produce a bindable quote.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

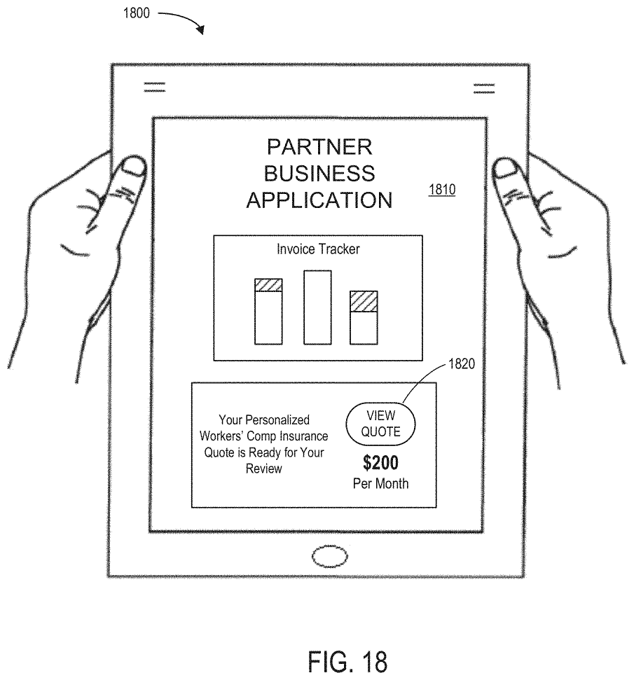

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., automobile insurance policies, health plans, etc.). Similarly, although certain attributes were described in connection some embodiments herein, other types of attributes might be used instead. Still further, the displays and devices illustrated herein are only provided as examples, and embodiments may be associated with any other types of user interfaces. For example, FIG. 18 illustrates a handheld tablet computer 1800 showing a partner business application interface 1810 according to some embodiments. The partner business application interface 1810 might include both business information and an insurance offer from an insurance company. The interface 1820 may include user-selectable data that can be activated or modified by a user of the handheld computer 1800 to provide more detailed insurance information associated with an insurance quote and/or to generate a physical result (e.g., via a “View Quote” icon 1820).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system with an automated risk relationship finalization computer server associated with an enterprise, comprising:
(a) an automated potential risk relationship platform, coupled to a remote partner platform, programmed to:
(i) ingest potential risk relationship data received from the remote partner platform, the potential risk relationship data being associated with an entity and including an entity identifier,
(ii) supplement the potential risk relationship data with third-party data received from a remote third-party platform,
(iii) determine that the supplemented potential risk relationship data qualifies for a resource calculation process,
(iv) if the supplemented potential risk relationship data qualifies for the resource calculation process, automatically calculate a resource value for the entity based on the supplemented potential risk relationship data, and
(v) transmit an indication of the calculated resource value to the partner platform; and
(b) the automated risk relationship finalization computer server, coupled to the automated potential risk relationship platform, programmed to:
(i) receive an indication that the entity requested that a finalization process be executed, and
(ii) responsive to the received indication, execute the finalization process in accordance with the supplemented potential risk relationship data and the calculated resource value.

2. The system of claim 1, further comprising:
(c) a communication port, coupled to the automated risk relationship finalization computer server, to facilitate an exchange of data with a remote administrator platform to support a potential risk relationship interface display via a distributed communication network; and
(d) a potential risk relationship data store, coupled to the automated risk relationship finalization computer server, containing electronic records associated with the entity, each electronic record including an electronic record identifier and a set of attribute values including the calculated resource value.

3. The system of claim 1, wherein the potential risk relationship is associated with an insurance policy and the resource value is associated with an insurance premium amount.

4. The system of claim 3, wherein the entity comprises a small business owner.

5. The system of claim 3, wherein the insurance policy is associated with at least one of: (i) workers' compensation insurance, (ii) a business owner's insurance policy, (iii) general liability insurance, (iv) automotive insurance, (v) property insurance, (vi) casualty insurance, and (vii) group benefit insurance.

6. The system of claim 3, wherein the partner platform is associated with at least one of: (i) a payroll application, (ii) an accounting application, (iii) a human resource application, (iv) a tax preparation application, and (v) an enterprise resource management system application.

7. The system of claim 3, wherein the supplemented potential risk relationship data includes at least one of: (i) a business name, (ii) a business address, (iii) an industry code, (iv) a business age, (v) a number of employees, (vi) an amount of sales, (vii) a payroll value, (viii) a number of square feet associated with business building, (ix) a building type, and (x) a business communication address.

8. The system of claim 3, wherein the third-party data is associated with at least one of: (i) governmental data, (ii) credit score company data, (iii) map-based geographic data, and (iv) internal data associated with the enterprise.

9. The system of claim 3, wherein the resource calculation process is further based on a risk attribute filter associated with the entity.

10. The system of claim 3, wherein the indication received by the automated risk associated finalization computer server is received via at least one of: (i) the partner platform, (ii) a remote device associated with the entity, (iii) an agency platform, (iv) a web page, and (v) a telephone call.

11. The system of claim 3, wherein qualification for the resource calculation process includes at least one of: (i) determining if the entity is a current customer of the enterprise, (ii) determining if the enterprise is interested in the potential risk relationship, (iii) a type of insurance, and (iv) a business classification algorithm.

12. The system of claim 3, wherein the finalization process includes receiving from the entity adjustments to the supplemented potential risk relationship data, re-calculating the insurance premium amount based on the adjustment, and issuing an insurance policy in accordance with the re-calculated insurance premium amount.

13. A computerized method utilizing an automated risk relationship finalization computer server associated with an enterprise, comprising:
ingesting, at an automated potential risk relationship platform from a remote partner platform, potential risk relationship data associated with an entity including an entity identifier;
supplementing the potential risk relationship data with third-party data received from a remote third-party platform;
determining that the supplemented potential risk relationship data qualifies for a resource calculation process;
if the supplemented potential risk relationship data qualifies for the resource calculation process, automatically calculating a resource value for the entity based on the supplemented potential risk relationship data;
transmitting an indication of the calculated resource value to the partner platform;
receiving, at the automated risk relationship finalization computer server, an indication that the entity requested that a finalization process be executed; and
responsive to the received indication, executing the finalization process in accordance with the supplemented potential risk relationship data and the calculated resource value.

14. The method of claim 13, wherein the potential risk relationship is associated with an insurance policy, the resource value is associated with an insurance premium amount, and the entity comprises a small business owner.

15. The method of claim 14, wherein the insurance policy is associated with at least one of: (i) workers' compensation insurance, (ii) a business owner's insurance policy, (iii) general liability insurance, (iv) automotive insurance, (v) property insurance, (vi) casualty insurance, and (vii) group benefit insurance.

16. The method of claim 14, wherein the partner platform is associated with at least one of: (i) a payroll application, (ii) an accounting application, (iii) a human resource application, (iv) a tax preparation application, and (v) an enterprise resource management system application.

17. The method of claim 14, wherein the supplemented potential risk relationship data includes at least one of: (i) a business name, (ii) a business address, (iii) an industry code, (iv) a business age, (v) a number of employees, (vi) an amount of sales, (vii) a payroll value, (viii) a number of square feet associated with business building, (ix) a building type, and (x) a business communication address.

18. A non-tangible, computer-readable medium storing instructions, that, when executed by a processor, cause the processor to perform a method utilizing an automated risk relationship finalization computer server associated with an enterprise, the method comprising:
ingesting, at an automated potential risk relationship platform from a remote partner platform, potential risk relationship data associated with an entity including an entity identifier;
supplementing the potential risk relationship data with third-party data received from a remote third-party platform;
determining that the supplemented potential risk relationship data qualifies for a resource calculation process;
if the supplemented potential risk relationship data qualifies for the resource calculation process, automatically calculating a resource value for the entity based on the supplemented potential risk relationship data;
transmitting an indication of the calculated resource value to the partner platform;
receiving, at the automated risk relationship finalization computer server, an indication that the entity requested that a finalization process be executed; and
responsive to the received indication, executing the finalization process in accordance with the supplemented potential risk relationship data and the calculated resource value.

19. The medium of claim 18, wherein the potential risk relationship is associated with an insurance policy, the resource value is associated with an insurance premium amount, and the entity comprises a small business owner.

20. The medium of claim 18, wherein the third-party data is associated with at least one of: (i) governmental data, (ii) credit score company data, (iii) map-based geographic data, and (iv) internal data associated with the enterprise.

21. The medium of claim 18, wherein the resource calculation process is further based on a risk attribute filter associated with the entity.

22. The medium of claim 18, wherein the indication received by the automated risk associated finalization computer server is received via at least one of: (i) the partner platform, (ii) a remote device associated with the entity, (iii) an agency platform, (iv) a web page, and (v) a telephone call.

23. The medium of claim 18, wherein qualification for the resource calculation process includes at least one of: (i) determining if the entity is a current customer of the enterprise, (ii) determining if the enterprise is interested in the potential risk relationship, (iii) a type of insurance, and (iv) a business classification algorithm.

24. The medium of claim 18, wherein the finalization process includes receiving from the entity adjustments to the supplemented potential risk relationship data, re-calculating the insurance premium amount based on the adjustment, and issuing an insurance policy in accordance with the re-calculated insurance premium amount.
